(19) United States
(12) Patent Application Publication
(10) Pub. No.: US 2023/0177895 A1
(43) Pub. Date: Jun. 8, 2023

(54) METHOD FOR DESCALING A COMBUSTION ENGINE BY HYDROGEN INJECTION AND DESCALING STATION FOR IMPLEMENTING SAME

(71) Applicant: ALPHAGREEN DÉVELOPPEMENT, Besançon (FR)

(72) Inventor: Ludovic CHEVENEMENT, Besançon (FR)

(73) Assignee: ALPHAGREEN DÉVELOPPEMENT, Besançon (FR)

(21) Appl. No.: 17/925,159

(22) PCT Filed: May 11, 2021
(86) PCT No.: PCT/IB2021/053977

§ 371 Date: Nov. 14, 2022

(30) Foreign Application Priority Data
May 20, 2020 (FR) FR2005353

(51) Int. Cl. G07C 5/08; G07C 5/00; F02B 77/04; F02M 26/49; F02M 65/00; F01N 3/023; B08B 9/032; B08B 5/02; B08B 13/00

(52) U.S. Cl. CPC G07C 5/0808; G07C 5/008; G07C 5/0816; F02B 77/04; F02M 26/49; F02M 65/007; F01N 3/023; B08B 9/0325; B08B 5/02; B08B 13/00; B08B 2209/032

(57) ABSTRACT

A descaling method involves a tool for diagnosing the engine of a motor vehicle, which tool can interact with the control electronics system of the engine, not only for reading information and controlling certain members during a hydrogen injection cleaning procedure, but also for checking, in real time after cleaning, the state of the impacted members and updating the engine management parameters accordingly in the control electronics system. Thus, the electronic management of the engine may take account of the resetting (i.e. to the initial values or values close to the initial values) of the operating parameters of the engine which are sensitive to engine scaling, such as EGR valve mobility, valve lift, DPF clogging, injector needle mobility, etc.

### TECHNICAL FIELD

The present invention generally relates to internal combustion engine (or combustion engine) depollution techniques, and more specifically to a method for descaling a combustion engine by hydrogen injection, as well as a descaling station for its implementation.

The invention has applications, in particular, in maintaining internal combustion engines implemented in motor vehicles of all types, in the land vehicle field (personal and utility vehicles, road transport lorries, farming vehicles, military vehicles, site vehicles for public works or forestry works, etc.), but also in other fields, like marine or aeronautics, or also in generator combustion engines. The examples thus given are not limiting.

### PRIOR ART

The clogging of internal combustion engines of motor vehicles is mainly due to current motor vehicle traffic conditions, namely, in particular:
journeys are shorter and shorter, due to the development of instances of use of vehicles by individuals and professionals;
start-ups of engines are more and more frequent (due, in particular, to stop and start systems, aiming to reduce the overall consumption in urban environments);
the speed limitations are lower and lower, due to states' desires to reduce death on roads;
the quality of certain fuels sold in low cost stores, more and more often with no detergent additive for money-saving reasons, in order to lower the price displayed of the fuels sold;
more and more severe anti-pollution standards, which lead motor vehicle manufacturers to configure the operation of engines, being concerned about limiting measurable emissions during vehicle new model administrative validation tests;
low engine rev driving, more and more generally adopted by drivers, being concerned about economising fuel, the cost of which represents an increase share in household budgets.

Carbon residue from combustion (i.e. scale) is installed inside the engine, in particular in sensitive parts, such as:
the turbocharger (or turbo): scale prevents the supercharging blades from tilting;
the air inlet circuit: scale blocks the air inlet in the cylinder, which leads to an additional force of the engine;
valves: once scale is installed, the valve seat is no longer 100% sealed and this can affect the compression of the cylinder;
the EGR (Exhaust Gas Recirculation) system: exhaust gas transits this combustion residue and deposits it inside the EGR valve; an accumulation of scale alters its movement;
the injector head: scale prevents a good diffusion of the fuel during the injection;
the catalyst: scale blocks its air cells;
the diesel particle filter (DPF): scale leads to it clogging;
etc.

The descaling of an internal combustion engine aims to fight against the accumulation in the engine of this carbon residue, or soot, which is responsible for them clogging over time. This residue weakens the abovementioned parts of the engine, and cause damaging effects on the engine's performance and on the emission of damaging matter or particles into the environment.

In the past, each use was able to count, in a certain measurement and with various pleasure, on the detergents contained in high-end fuel, even, on so-called “descaling” additives, to keep their engine clean.

For a few years, the descaling of an engine by hydrogen injection appeared and offers an effective and inexpensive alternative as regards the benefits which can be expected from it. This method consists of injecting hydrogen inside the engine of a vehicle in the inlet of the engine, while making it operate a low revs, with the vehicle stopped, for a duration of between thirty minutes and around one and a half hours. This has the effect of removing the soot deposits inside the engine, this soot thus being burnt and/or released into the exhaust. The vehicle, once cleared from combustion residue which pollutes its engine, returns substantially all of the performance given by the manufacturer for a vehicle equipped with a new engine, and in particular decreases its fuel consumption.

Document FR3041997A discloses a descaling system comprising a control means arranged to control an opening or a closing of the EGR valve of the engine according to parameters of the injected cleaning fluid, in order to make the cleaning fluid circulate better in the top part of the engine, in the inlet circuit, and in the gas recirculation circuit. This controlling of the EGR valve which opens and closes during treatment allows it to be cleaned well.

Document FR3064025 discloses a cleaning installation comprising a diagnostic means adapted to determine a clogging rate of a motorisation system comprising an internal combustion engine according to intrinsic parameters of said motorisation system, and a means for controlling a device for injecting a cleaning fluid of the motorisation system adapted to provide said injection device with cleaning parameters according to the clogging rate of the motorisation system. Thus, the fluid injection is adjusted taking account of a clogging rate of the motorisation system depending on the intrinsic parameters of the motorisation system, like for example, the geometry of the engine, the number and the diameter of the cylinders, etc., for a better effectiveness of the cleaning.

In the cleaning installation according to document FR3064026, moreover, a diagnostic means is arranged to determine a clogging rate of the motorisation system according to a defectiveness rate of at least one of the movable parts, and a control means arranged to provide the injection device with cleaning parameters for the implementation of the cleaning sequence, said cleaning parameters according to the clogging rate of the motorisation system. Thus, the cleaning fluid injection is adjusted taking account of a clogging rate of the motorisation system according to a defectiveness rate of at least one movable part. The cleaning sequence is thus adapted to the real need of the engine, and not based only on a statistical clogging state of the engine.

The state of the art summarised above reveals that the general principle of descaling an internal combustion engine by hydrogen injection forms the subject of continuous improvements, mainly resulting from interaction with the vehicle specifically in question by the current operation.

However, it seems that this interaction with said vehicle, even if it makes it possible to take account of the state of the vehicle just before the performance of the operation, can also be improved.

In particular, all internal combustion engines of modern vehicles are electronically managed, by one (or more) on-board management boxes. These management boxes each comprise at least one computer which controls the operation of the engine according to various parameters, like the engine system (slowing down, acceleration, etc.), the engine's charge (full charge, engine brake, etc.), the acceleration request (deceleration, resumption), the engine's temperature, the operating phase (cold start-up, city journey with frequent stops and restarts if a “stop and start” function is implemented, etc.), and others too. Thanks to this technology, all the factors of good operation are taken into account to adjust certain engine control parameters, like the duration of the injection, the moment of pre-injection, the injection and the post-injection, etc.

The clogging of the engine, which forms part of the parameters associated with the ageing of engine parts, is also taken into account by these electronic management boxes of the engine, as a slow development parameter.

This being so, injecting hydrogen in order to remove or reduce scale inside the engine during a descaling operation, has the effect that the electronic management of the engine is suddenly no longer in phase with the real state of the parts which are more particularly subject to scaling. These parts are indeed, from the standpoint of electronic management boxes of the engine, considered as intrinsically clogged with the effect of reducing the efficiency of their operation with respect to what was commissioned of the engine. However, these parts are found to be, all of a sudden, partially or totally regenerated due to the descaling operation which has just been carried out. For this reason, the parameters taken into account by the electronic management boxes of the engine which are linked to clogging (valve lift height, injector opening rate, DPF scaling rate, etc.) become at least partially erroneous as soon as the ageing effects attributed to the progressive formation of scale in the engine totally or partially disappear due to the descaling operation carried out.

### SUMMARY OF THE INVENTION

The invention aims to improve the situation and proposes, to this end, in substance, to inform all of the electronic management boxes of the engine to carry out a descaling operation. Thus, the electronic management of the engine can take account of the resetting (i.e. to the initial values or to values closes to said initial values) of the operating parameters of the engine which are sensitive to the scaling of the engine, like EGR valve mobility, valve lift, DPF clogging, injector needle mobility, etc.

This aim is achieved, thanks to a cleaning method involving a motorisation unit diagnostic tool, which can interact with the control electronics system of the engine, not only for reading information and controlling certain members during the cleaning procedure, but which further can vary the state of the members impacted by the cleaning and updating of the management parameters of the engine in real time accordingly in the control electronics system of the motorisation unit.

More specifically, a method for cleaning a motor vehicle motorisation unit comprising an internal combustion engine is proposed, said method comprising:
the reading by a diagnostic tool connected to the motor vehicle, faults of the motorisation unit possibly highlighted by the control electronics system of the motorisation unit during the prior operation of the motorisation unit and stored, if necessary, in a memory of said control electronics system;
the reading by the diagnostic tool in real time, engine turned on, of operating parameters of the motorisation unit, and the establishment of a diagnosis relating to the clogging of members of the motorisation unit according to the faults highlighted, if necessary, as well as said operating parameters of the motorisation unit;
the connection to the vehicle of a station for cleaning the motorisation unit by injection of a cleaning fluid, said cleaning station being further connected;
under the control of the diagnostic tool and according to a cleaning procedure which depends on the diagnosis established, cleaning of the motorisation unit by injection, engine turned on, of a cleaning fluid in the inlet of the engine by a cleaning station connected to the motor vehicle and connected to the diagnostic tool for the effect of it being controlled by said diagnostic tool, with simultaneous movement, also under the control of the diagnostic tool, of movable members of the motorisation unit comprised among the members of said motorisation unit which are sensitive to clogging;
the removal by the diagnostic tool of the faults highlighted, if necessary, of the memory of the control electronics system of the motorisation unit;
the learning, after the cleaning operation, by the diagnostic tool, in real time, engine turned on, of the effective state of self-adaptive members of the motorisation unit comprised among the members of said motorisation unit which are sensitive to clogging; and,
the updating by the diagnostic tool, in the control electronics system of the motorisation unit, of operating parameters of said motorisation unit normally impacted by the clogging of members of said motorisation unit which are sensitive to clogging, to take account of the effective state, after the cleaning operation, of the self-adaptive members of the motorisation unit from among the members of said motorisation unit which are sensitive to clogging.

Embodiments, taken individually or in combination, further provide that:
the cleaning of the engine can be carried out for a duration which further depends on intrinsic parameters of the motorisation unit, like the engine's cylinder;
the members of the motorisation unit which are sensitive to clogging comprise, in particular, the turbo, the diesel particle filter, the EGR valve, the bypass box, the valves, the exhaust valve, and the injectors;
the movable members of the motorisation unit from among the members of said motorisation unit which are sensitive to clogging comprise, in particular, the turbo, the exhaust valve, the EGR valve, the valves and the injectors;
the self-adaptive members of the motorisation unit from among the members of said motorisation unit which are sensitive to clogging comprise, in particular, the EGR valve, the exhaust valve and the valves;
the diagnostic tool can be a connected tablet, associated with the cleaning station;
the diagnostic tool can be connected to the control electronics system of the motorisation unit by way of the OBD connector of the vehicle;
the cleaning station can be operationally connected to the diagnostic tool by way of a USB connection, a Bluetooth™ connection, or a Wi-Fi™ connection; and/or
the cleaning fluid can be hydrogen.

In a second aspect, the invention also aims for a diagnostic tool adapted to be operationally connected to a cleaning station, by injection of a cleaning fluid, of a motor vehicle motorisation unit comprising an internal combustion engine, said diagnostic tool comprising means for the implementation of all the steps of the method according to the first aspect above.

A third aspect of the invention relates to a cleaning installation of a motor vehicle motorisation unit comprising an internal combustion engine, said installation comprising a cleaning station adapted for the injection of a cleaning fluid in the motorisation unit, engine turned on, and a diagnostic tool according to the second aspect above, adapted to be operationally connected to a cleaning station in order to implement the method according to the first aspect.

In a fourth and last aspect, the invention also aims for a computer program product comprising one or more instruction sequences stored on a memory medium which can be read by a machine comprising a processor, said instruction sequences being adapted to carry out all the steps of the method according to the first aspect of the invention when the program is read in the memory medium and executed by the processor.

A drop of 10 to 38% of consumption for a depolluted vehicle can be noted, thanks to the implementation of the invention. The system proposed, in view of such costed elements, demonstrates its effectiveness, as well in terms of energy saving, as regarding respecting the environment and taking account of the public health problems linked to air quality.

### BRIEF DESCRIPTION OF THE DRAWINGS

Other features and advantages of the invention will also appear upon reading the following description. This is purely illustrative and must be read regarding the accompanying drawings, wherein:

FIG. 1 is a functional diagram schematically illustrating a cleaning installation of a motorisation unit of a motor vehicle comprising an internal combustion engine, with a diagnostic tool and a descaling station, wherein embodiments of the invention can be implemented; and,

FIG. 2 is a step diagram illustrating the implementation of the method of the invention.

### DESCRIPTION OF EMBODIMENTS

In the description of embodiments below and in the figures of the accompanying drawings, the same elements or similar elements have the same numerical references to the drawings.

An internal combustion engine discards, during its operation, gases and damaging products such as;
carbon dioxide (CO₂) responsible for heating up the atmosphere;
carbon monoxide (CO) which is partially responsible for the increase in cardiovascular diseases;
unburnt hydrocarbons (HC) which are carcinogenic; and,
nitrogen monoxide and dioxide (which are mainly called NOx) in the form of fine particles which are highly damaging for the pulmonary system of human beings.

Despite the efforts implemented to reduce these emissions, in particular by reducing fuel consumption by combustion engines, but also by implementing depollution techniques, the impact of human activities involving the use of combustion engines remains concerning for the planet and for humanity.

Descaling is a method for cleaning motorisation units comprising an internal combustion engine, which contributes to reducing emissions of abovementioned pollutant products, by fighting against the accumulation of carbon soot in the members in question, which is responsible for the drop in performance of vehicles and the increase in pollutants with the age of the vehicle.

It is reminded that the technique of descaling a combustion engine by hydrogen injection consists of injecting hydrogen inside the engine, while the engine operates with low revs. This hydrogen is produced only as demineralised water-based. No chemical product is added. That is why, and although other cleaning fluids can be considered, hydrogen is currently the most common. That is also why the embodiments considered here relate to a cleaning of a motorisation unit by hydrogen injection. A person skilled in the art will assess, however, that the implementation of the invention is not limited to this example.

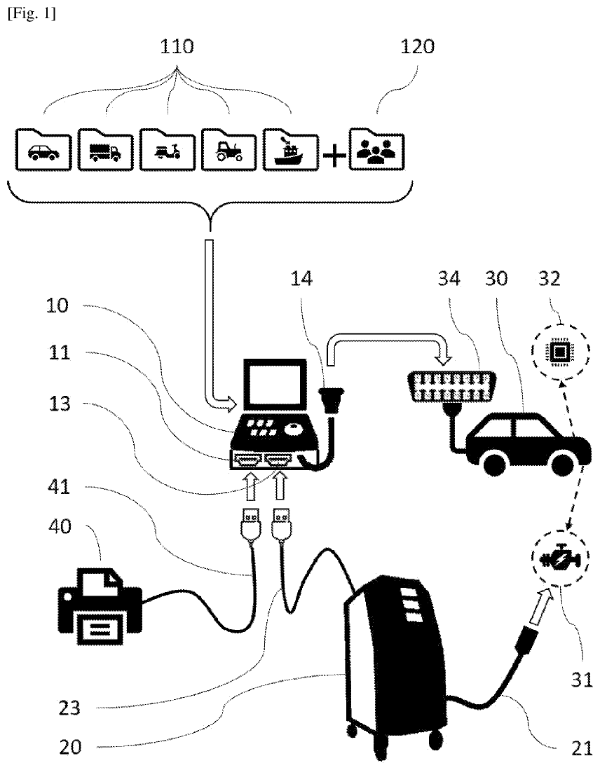

The hydrogen injection in particular makes it possible:
to reduce the emission by the engine of damaging particles into the atmosphere (CO, CO₂, NOx and HC);
to reduce fuel consumption (factor observed by the drop in CO₂ and HC emission);
to improve the performance of the engine (torque and power); and,
to clean and regenerate parts subject to wear, such as injectors, and if necessary, the turbo, the EGR valve, the diesel particle filter (DPF), etc., which provides a reduction of risks of changing these expensive parts and therefore an indirect, but substantial saving for the owner of the vehicle.

[FIG. 1] shows, very schematically, a functional diagram of a cleaning installation of a motorisation unit 31 of a motor vehicle 30 comprising an internal combustion engine, with a diagnostic tool 10 and a descaling station 20, wherein embodiments of the invention can be implemented. As will become clearer for a person skilled in the art in the light of the description which will be given below, the steps of the method are more particularly carried out by, or under the direct control of the diagnostic tool. The intervention of the operator can be limited to the connection of the appliances, and to the triggering of the operation of the tool which then performs relatively automatically, in particular to control the cleaning station 20 and to access in reading/writing the control electronics system 32 of the motorisation unit 31 of the motor vehicle 30.

In an embodiment, the diagnostic tool can be a connected tablet, associated with the cleaning station 20, or a functionally equivalent device like a smartphone or a laptop computer, equipped with software and an interface to communicate with the on-board computers of the control electronics system 32. In a variant, it can be a diagnostic case available on the market equipped with software for vehicles of the main makes (this can also be called “multi-make case”), or a desktop computer, equipped in the same way, and equipped with an interface to communicate with the on-board computers.

It will be noted that, in all the embodiments, the diagnostic tool is sold with no software and no datafile corresponding to cleaning procedures. The user of the cleaning station can apply exclusive procedures that they will have developed closely with the cleaning station that they use in relation to the connected diagnostic tool.

They can also install in the diagnostic tool 10, diagnostic software 110 corresponding to the different types of motor vehicles managed in their workshop (light-duty passenger vehicles, heavy-duty utility vehicles, farming vehicles, site vehicles, boats and ships, diesel engine railway vehicles, aircraft, etc.), and if necessary, a customer file 120 which will seem the most suitable for them.

For example, the diagnostic tool 10 can be connected to the control electronics system 32 of the motorisation unit 31 by way of the OBD connector, referenced 34, of the vehicle 30, via an interface cable 14. The OBD standard is the only standard for all motor vehicle manufacturers. It is the on-board diagnostic standard, which aims to enable the control of pollutant emissions by being capable of detecting the probable origin of a malfunctioning by means of error codes stored in the memory of the computer, in particular during technical control sessions. According to the specifications of this standard, applicable in Europe, furthermore, when a major OBD fault code is detected, the computer illuminates the engine depollution light on the dashboard. In a variant, the operational connection between the tool 10 and the control electronics system 32 can also occur by other means, wired or wireless.

By the expression, connected tablet “associated” with the cleaning station 20, this means that it can be provided with said cleaning station, by the manufacturer of the latter. But, this can also be a digital tablet available on the market, smart and connecting, wherein an app can be executed which implements the method and which comprises operational connection means, wired or wireless, with the cleaning station 20. In summary, the diagnostic tool 10 can be connected to the cleaning station 20 by way of a wired connection 23, 13 like a USB™ connection established by a USB™ cable 23 of the station with a USB™ connector 23 of the tool 10, for example a USB-3™ connection, or by a wireless connection, for example a Bluetooth™ connection or a Wi-Fi™ connection.

The cleaning station 20 further comprises a pipe 21 to deliver the cleaning fluid, in this case hydrogen, to the motorisation unit 31 of the motor vehicle 30, via a means for ad-hoc connecting to the vehicle. More specifically, hydrogen is injected into the inlet of the engine, for example, via the air inlet hose (or conduit). This can occur downstream from the air filter, for a positive ignition vehicle (or so-called “petrol” vehicle), or downstream from the EGR valve for a diesel vehicle.

Finally, [FIG. 1] shows that the diagnostic tool 10 can also comprise connectivity means, like another USB™ connector 11, to be connected by a USB™ cable 41, to a peripheral 40 like a printer, which makes it possible to print diagnostic reports, advantageously before and after the cleaning performed. Naturally, any other connectivity interface, like Bluetooth™ or Wi-Fi™ can be considered. Moreover, the tool can also be adapted to be connected to any other equipment in the workshop, like a gas analyser for example, for the analysis, simultaneous or not, of the quantity of the composition of exhaust gases, advantageously before and after the cleaning performed.

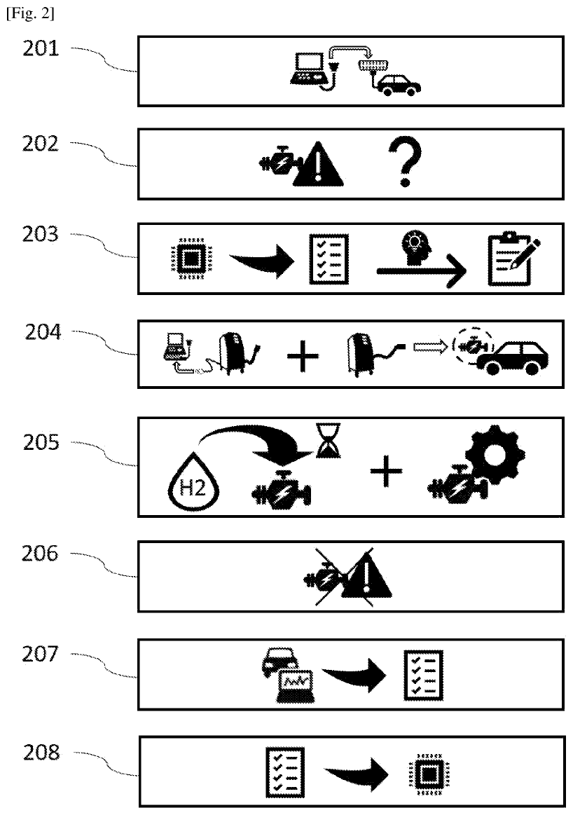

In reference to the step diagram of [FIG. 2], the implementation of the cleaning method of the motorisation unit of the motor vehicle 30 of [FIG. 1] will now be described.

First, it will be noted that a standard implementation of an engine cleaning by hydrogen injection according to the prior art comprises the following steps, implemented by an operator in a specialist workshop
the reading of possible faults;
the connection of the descaling station to the inlet of the engine, for example after the air filter for a positive ignition engine, or after the EGR valve for a diesel engine;
the hydrogen injection according to the method recommended by the manufacturer of the station (in particular, for a time according to the information provided by the manufacturer of the station);
then the stopping of the hydrogen injection;
the reading and the removal of the engine faults; and finally
the return of the vehicle to the customer.

In step 201 of the method according to the embodiments of the invention illustrated by the step diagram of [FIG. 1], an operator performs the connection of the diagnostic tool 10 to the motor vehicle 30, for example via the OSB connector referenced 34 of said vehicle.

In step 202, the diagnostic tool 10 performs the reading of faults of the motorisation unit possibly highlighted by the control electronics system 32 of the motorisation unit comprising the internal combustion engine 31, during the prior operation of the motorisation unit. Such faults are conventionally stored, if necessary, in a non-volatile memory of the control electronics system 32, for example an EEPROM (Electrically Erasable and Programmable Read-only Memory) memory, or a Flash memory.

Step 203 comprises the reading by the diagnostic tool 10, in real time and engine turned on, of operating parameters of the motorisation unit. It also comprises the establishment, always by the diagnostic tool 10, of a diagnosis relating to the clogging of members of the motorisation unit according to the faults highlighted, if necessary, as well as the operating parameters of the motorisation unit read in the memory of the electronics 32. A person skilled in the art will assess that these are members of the motorisation unit which are sensitive to clogging by carbon residue (scale), in particular the turbo, the diesel particle filter, the EGR valve, the bypass box, the exhaust valve, the valves controlled by the variable valve timing (VVT) system, and the injectors. This list is not exhaustive.

In step 204, the operator performs the connection to the vehicle 30 of the cleaning station 20, which is adapted to ensure the cleaning of the motorisation unit by injection of a cleaning fluid, namely hydrogen in the example. The cleaning station 20 is further connected to the diagnostic tool 10 to perform under the control of said diagnostic tool, in the scope of the cleaning procedure established by this tool.

This cleaning procedure is, for example, established based on standard procedures, one of which is selected and adapted (by the configuration of ad-hoc parameters, for example) according to the faults noted in step 202 and from the diagnostic established in step 203, in particular.

In a first example, if faults are noted and/or if malfunctions are observed at the EGR system, the cleaning procedure can provide:
heating the engine to 80° C.;
connecting the hydrogen pipe in the air hose located after the air filter;
starting the hydrogen injection once the engine is turned on;
letting the engine run at a slow speed for 60 minutes by controlling the opening and the closing of the gas recycling valve using the diagnostic software;
then, for 30 minutes, making the engine speed vary according to the operating range of the EGR valve;
then, accelerating the engine speed to 2300 rpm for 30 minutes; and finally,
stopping the hydrogen injection, then reconnecting the air hose.

In a second example, if faults are noted and/or if malfunctions are observed at the diesel particle filter (DPF), the cleaning procedure can provide:
raising the differential pressure value of the DPF;
heating the engine to 80° C.;
connecting the hydrogen pipe in the air hose located after the air filter;
starting the hydrogen injection once the engine is turned on;
letting the engine run at a slow speed for 60 minutes;
accelerating the engine speed to 1800 rpm for 30 minutes;
accelerating the speed to 2700 rpm for 30 minutes; then finally,
stopping the hydrogen injection, then reconnecting the air hose.

In a third example, if faults are noted and/or if malfunctions are observed at the EGR system, the cleaning procedure can provide:
heating the engine to 80° C.;
connecting the hydrogen pipe in the air hose located after the air filter;
starting the hydrogen injection once the engine is turned on;
letting the engine run at a slow speed for 50 minutes;
accelerating the engine speed to 1800 rpm for 30 minutes;
making the engine speed vary from the start to the end of the supercharging range for 30 minutes; and finally,
stopping the hydrogen injection, then reconnecting the air hose.

A person skilled in the art will assess that these examples are not limiting at all.

The cleaning procedure can also, generally, provide that the cleaning of the engine will be performed for a duration which further depends on intrinsic parameters of the motorisation unit, like the engine's cylinder, the age and/or the total mileage travelled by the vehicle since it was commissioned, etc. Other more subjective parameters, like the type of dominant use of the vehicle (small, daily journeys on city routes, or on the contrary, occasional, long journeys on the motorway, for example) and directly entered by the operator in the diagnostic tool 10 (insofar as they are known) or collected from the customer datafile 120, for example, can also be taken into account to establish the cleaning procedure most suitable for the particular case of the vehicle to be descaled.

In step 205, the diagnostic tool controls the cleaning of the motorisation unit by injection, engine turned on, of the cleaning fluid in the inlet of the engine, namely hydrogen in the example considered in this case. During this step, and at the same time as the hydrogen injection is performed, the movable members of the motorisation unit comprised among the members of said motorisation unit which are sensitive to clogging are preferably moved, according to the methods belonging to the cleaning procedure mentioned in the preceding paragraph, which depends on the diagnosis established. For example, the movable members of the motorisation unit among the members of said motorisation unit which are sensitive to clogging comprise the turbo, the EGR valve, the exhaust valve, the valves and the injectors. This list is not exhaustive.

In step 206, the diagnostic tool controls the removal of faults highlighted before cleaning, if necessary, of the memory of the control electronics system 32 of the motorisation unit of the vehicle 30.

In step 207, the diagnostic tool 10 further learns, after the cleaning operation, in real time and engine turned on, of the effective state of the self-adaptive members of the motorisation unit which are comprised among the members of said motorisation unit which are sensitive to clogging. For example, the self-adaptive members of the motorisation unit among the members of said motorisation unit which are sensitive to clogging comprise the EGR valve, the exhaust valve and the valves (through the VVT system). This list is not exhaustive either.

Finally, in step 208, the diagnostic tool performs the update, in the control electronics system 32 of the motorisation unit of the vehicle 10, operating parameters of said motorisation unit which are normally impacted by the clogging of members which are sensitive to clogging. This makes it possible, advantageously, to take account of the effective state, after the cleaning operation, of the self-adaptive members of the motorisation unit among the members of said motorisation unit which are sensitive to clogging. In other words, the operation of the motorisation unit after cleaning by hydrogen injection will take account of the return of said members to an identical state to or close to their initial state, during the commissioning of the vehicle 10. The reduction of consumption and fuel and the emission of damaging products into the atmosphere are therefore optimised, likewise the performance of the vehicle.

A person skilled in the art will assess that the order of step 206, on the one hand, and steps 207 and 208, on the other hand, is indifferent.

The present invention has been described and illustrated in the present detailed description and in the figures of the accompanying drawings, in possible embodiments. The present invention is not limited, however, to the embodiments presented. Other variants and embodiments can be deduced and implemented by a person skilled in the art upon reading the present description and the accompanying drawings.

In the claims, the term “comprise” or “has” does not exclude other elements or other steps. One single processor or several other units can be used to implement the invention. The different features presented and/or claimed can be advantageously combined. Their presence in the description or in different dependent claims, do not exclude this possibility. The reference signs could not be understood as limiting the scope of the invention.

1. A method for cleaning a motor vehicle motorisation unit comprising an internal combustion engine, said method comprising:
the reading by a diagnostic tool connected to the motor vehicle, of faults of the motorisation unit possibly highlighted by a control electronics system of the motorisation unit during the prior operation of the motorisation unit and stored, if necessary, in a memory of said control electronics system;
the reading by the diagnostic tool in real time, engine turned on, of operating parameters of the motorisation unit, and the establishment of a diagnosis relating to the clogging of members of the motorisation unit according to the faults highlighted, if necessary, as well as said operating parameters of the motorisation unit;
the connection to the vehicle of a cleaning station of the motorisation unit by injection of a cleaning fluid, said cleaning station being further connected;
under the control of the diagnostic tool and according to a cleaning procedure which depends on the diagnostic established, cleaning of the motorisation unit by injection, engine turned on, of a cleaning fluid in the inlet of the engine by a cleaning station connected to the motor vehicle and connected to the diagnostic tool to the effects of its control by said diagnostic tool, with simultaneous movement, also under the control of the diagnostic tool, movable members of the motorisation unit comprised among the members of said motorisation unit which are sensitive to clogging;
the removal by the diagnostic tool of the faults highlighted, if necessary, of the memory of the control electronics system of the motorisation unit;
the learning, after the cleaning operation, by the diagnostic tool, in real time, engine turned on, of the effective state of self-adaptive members of the motorisation unit comprised among the members of said motorisation unit which are sensitive to clogging; and
the updating by the diagnostic tool, in the control electronics system of the motorisation unit, of operating parameters of said motorisation unit normally impacted by the clogging of members of said motorisation unit which are sensitive to clogging, to take account of the effective state, after the cleaning operation, of the self-adaptive members of the motorisation unit among the members of said motorisation unit which are sensitive to clogging.

2. The method according to claim 1, wherein the cleaning of the engine is performed for a duration which further depends on intrinsic parameters of the motorisation unit, including a cylinder of the engine.

3. The method according to claim 1, wherein the members of the motorisation unit which are sensitive to clogging comprise the turbo, the diesel particle filter, the EGR valve, the bypass box, the valves, the exhaust valve, and the injectors.

4. The method according to claim 3, wherein the movable members of the motorisation unit among the members of said motorisation unit which are sensitive to clogging comprise the turbo, the exhaust valve, the EGR valve, the valves and the injectors.

5. The method according to claim 3, wherein the self-adaptive members of the motorisation unit among the members of said motorisation unit which are sensitive to clogging comprise the EGR valve, the exhaust valve and the valves.

6. The method according to claim 1, wherein the diagnostic tool is a connected tablet, associated with the cleaning station.

7. The method according to claim 1, wherein the diagnostic tool is connected to the control electronics system of the motorisation unit by way of the OBD connector of the vehicle.

8. The method according to claim 1, wherein the cleaning station is operationally connected to the diagnostic tool by way of a USB™ connection, a Bluetooth™ connection, or a Wi-Fi™ connection.

9. The method according to claim 1, wherein the cleaning fluid is hydrogen.

10. A diagnostic tool adapted to be operationally connected to a cleaning station, by injection of a cleaning fluid, of a motor vehicle motorisation unit comprising an internal combustion engine, said diagnostic tool comprising means for the implementation of all the steps of the method according to claim 1.

11. A cleaning installation of a motor vehicle motorisation unit comprising an internal combustion engine, said installation comprising a cleaning station adapted for the injection of a cleaning fluid in the motorisation unit, engine turned on, and the diagnostic tool according to claim 10 adapted to be operationally connected to a cleaning station in order to implement the method.

12. A computer program product embodied on a non-transitory computer readable medium and comprising one or more instruction sequences stored on a memory medium which can be read by a machine comprising a processor, said instruction sequences being adapted to carry out all the steps of the method according to claim 1 when the program is read in the memory medium and executed by the processor.

13. The method according to claim 2, wherein the members of the motorisation unit which are sensitive to clogging comprise the turbo, the diesel particle filter, the EGR valve, the bypass box, the valves, the exhaust valve, and the injectors.

14. The method according to claim 4, wherein the self-adaptive members of the motorisation unit among the members of said motorisation unit which are sensitive to clogging comprise the EGR valve, the exhaust valve and the valves.

15. The method according to claim 2, wherein the diagnostic tool is a connected tablet, associated with the cleaning station.

16. The method according to claim 3, wherein the diagnostic tool is a connected tablet, associated with the cleaning station.

17. The method according to claim 4, wherein the diagnostic tool is a connected tablet, associated with the cleaning station.

18. The method according to claim 5, wherein the diagnostic tool is a connected tablet, associated with the cleaning station.

19. The method according to claim 2, wherein the diagnostic tool is connected to the control electronics system of the motorisation unit by way of the OBD connector of the vehicle.

20. The method according to claim 3, wherein the diagnostic tool is connected to the control electronics system of the motorisation unit by way of the OBD connector of the vehicle.
